(19) United States
(12) Patent Application Publication
(10) Pub. No.: US 2010/0133016 A1
(43) Pub. Date: Jun. 3, 2010

(54) Scales

(75) Inventors: Jevgenij Mannhart, Cham (CH); Cyrill Röthlin, Hunenberg (CH); Marc Robert, Kossnacht (CH); Jéôme Bernhard, Zurich (CH)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: CARAG AG, Baar (CH)

(21) Appl. No.: 12/598,620

(22) PCT Filed: Apr. 23, 2008
(86) PCT No.: PCT/CH08/00185

§ 371 Date: Dec. 4, 2009

(30) Foreign Application Priority Data
May 4, 2007 (CH) 734/07

(51) Int. Cl. G01G 7/02

(52) U.S. Cl. 177/25.12; 177/210 EM

(57) ABSTRACT

The invention relates to a scale having a base plate (1), a bed plate (2) located at a distance above the base plate (1) for supporting an object to be weighed, and elastic spacing elements (3) located between the base plate (1) and the bed plate (2). Said scale further comprises a weighing means for determining the weight of the object, said weighing means being at least one inductive proximity sensor (10, 20, 4). Said scale is robustly constructed and allows great flexibility in the external design of the scale.

### TECHNICAL FIELD

The invention relates to a set of scales according to the preamble of patent claim 1.

### PRIOR ART

A wide variety of scales are known in the prior art. They usually have either a mechanical counterbalance or they have springs or bending beams in order to measure the loading weight. It is furthermore known to use proximity sensors in order to set the zero value of the scales or to compensate for uneven loading of the scales.

DE 38 119 42 A1, for example, discloses a set of electronic scales with corner load sensors, which scales have a first measurement arrangement with a coil and a position sensor for measuring the weight and a second measurement arrangement with another coil for measuring the bending of the weighing tray. The weight is measured by detecting a compensation current which is necessary to produce a compensation force for compensating the weight of the goods to be weighed. For this, the position sensor is used to detect a movement indicated by the weighing operation and a corresponding signal is transmitted to the coil for producing the compensation force. The bending of the tray is measured by the second coil in order to compensate for errors in the weight measurement caused by uneven loading of the weighing tray. The two measurements are carried out independently of one another and are only connected to one another by a signal processing system.

U.S. Pat. No. 5,773,767 illustrates, for example, a set of scales with a bending beam and a Hall sensor which carries out an automatic zero setting after the removal and replacement of a weighing platform.

U.S. Pat. No. 4,503,922 relates to electronic bathroom scales having a flat coil sensor for measuring distances. Here, arms or struts are provided between a weighing area and a baseplate, are connected to a spring apparatus and transfer a movement of the arms due to the action of a weight force to the sensor. The sensor substantially comprises a positionally fixed plate on which one or two coil circuits are provided and a movable plate on which the arms act.

U.S. Pat. No. 5,717,167 describes a vehicle weighbridge having an inclinometer which compensates for any tilt of the scales. WO 03/007072 also measures the tilt, in this case the tilt of a forklift, in order to correct the weight measurement.

U.S. Pat. No. 4,507,742 describes a weighing system for aircraft having an inclinometer for determining the weight of the aircraft.

In the case of large scales for vehicles or aircraft, the maximum loading capacity is of principal importance. In particular in the case of household and bathroom scales, however, the demands placed on external appearance are very high. Sadly, measurement technology adversely affects the degree of creative freedom, since springs, bending beams, electronics and any cables should be integrated in the scales if possible such that they are not visible from the outside. The scales should also be very robust so that it can also be transported and withstand any impacts or other impairments.

### DESCRIPTION OF THE INVENTION

It is thus an object of the invention to provide a set of scales which is robust and allows as much flexibility as possible in the external design of the scales.

This object is achieved by a set of scales having the features of patent claim 1.

The set of scales according to the invention has a baseplate, a placement plate, which is arranged at a distance above the baseplate, for the placement of an object to be weighed, resilient distance elements which are arranged between baseplate and placement plate, and a weighing means for determining the weight of the object. The weighing means is formed by at least one inductive proximity sensor comprising an electric coil and a metallic, ferromagnetic or paramagnetic reference plate, wherein the at least one coil is arranged in one of the placement plate and baseplate, and the reference plate is arranged in the respective other of placement plate and baseplate or formed therefrom. That means that the coil is arranged either in the placement plate or the baseplate, and the reference plate is arranged in the respective other of the two plates or is formed therefrom.

This set of scales needs relatively few and only small individual components, which are also hardly susceptible to disruption. They are also cheap. The individual components need not be connected mechanically or electronically for the evaluation of the measurement, such that they hardly influence the external design of the scales. This set of scales is particularly suitable as bathroom or household scales, but not exclusively so. The set of scales is particularly suitable for weighing objects in motion, for example babies.

The proximity sensor preferably uses the same measurement principle as is disclosed in EP 0 913 857. Here, a method and a device for aligning a bonding head of a bonder are described, which method and device use inductive distance measurement as the measurement principle.

The distance elements are preferably arranged such that they are distributed on in an edge region of the baseplate and of the placement plate and the at least one proximity sensor is situated in the central region of the baseplate and of the placement plate. Since an inductive proximity sensor is used, even very small distance deviations can be measured.

Since the weighing means comprises merely inductive proximity sensors, which in turn comprise flat coils, which are integrated in a printed circuit board, and associated reference plates, the set of scales has a very robust structure. The inductive proximity sensors advantageously allow contactless measurement and do not require cable connections. As a result, the placement plate or all the components which come into contact with the object to be measured can be arranged completely separately from the entire electronic system.

Even in the case of non-elastic restoring of the placement plate, it is possible to readily achieve a zero setting of the scales by taking the new distance between coil and reference plate as the zero value. Owing to the use of a plurality of coils, in particular three or four coils, it is possible to automatically detect and compensate for tilts of the placement plate with respect to the perpendicular and also with respect to the baseplate. Owing to the relatively small proximity coils, which can additionally be arranged together on a common printed circuit board, cabling, which would have to be laid over large distances along the scales, are not necessary. Additionally, no mechanical measurement means are necessary. The weighing means thus influences the design of the scales only to a minimum extent. In particular, transparent placement plates and baseplates can be used.

Further advantageous embodiments emerge from the dependent patent claims.

### BRIEF DESCRIPTION OF THE DRAWINGS

The subject of the invention will be explained below using preferred exemplary embodiments which are shown in the attached drawings, in which:

FIG. 1 shows a plan view of a set of scales according to the invention according to a first embodiment;

FIG. 2 shows a side view of the set of scales according to FIG. 1;

FIG. 3 shows a cross section through the set of scales according to FIG. 1;

FIG. 4 shows an enlarged illustration of a detail according to FIG. 3;

FIG. 5 shows a side view of a set of scales according to a second embodiment of the invention;

FIG. 6 shows a cross section through the set of scales according to FIG. 5 and

FIG. 7 shows an enlarged illustration of a detail according to FIG. 6.

### APPROACHES FOR IMPLEMENTING THE INVENTION

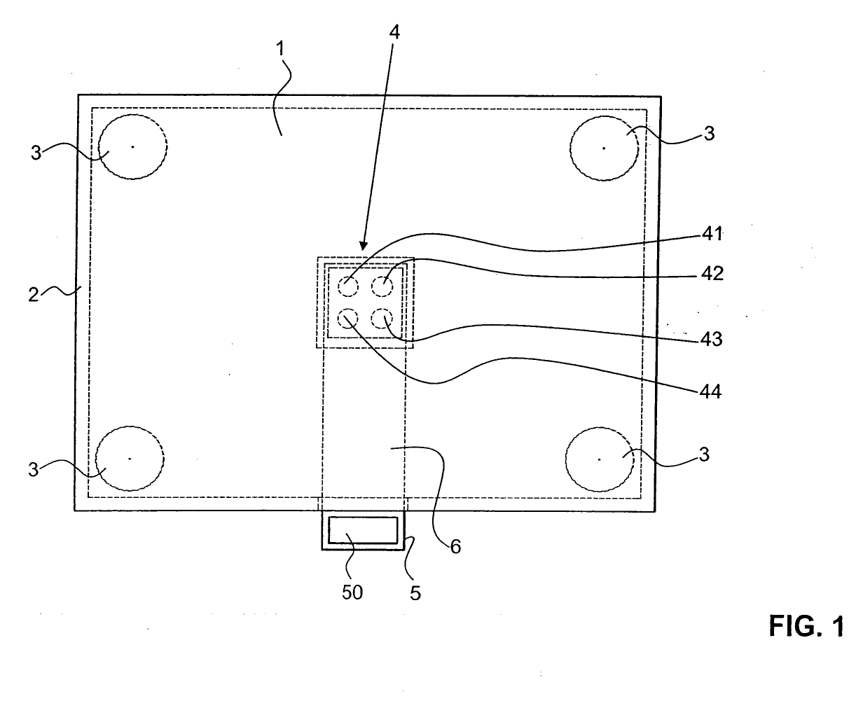

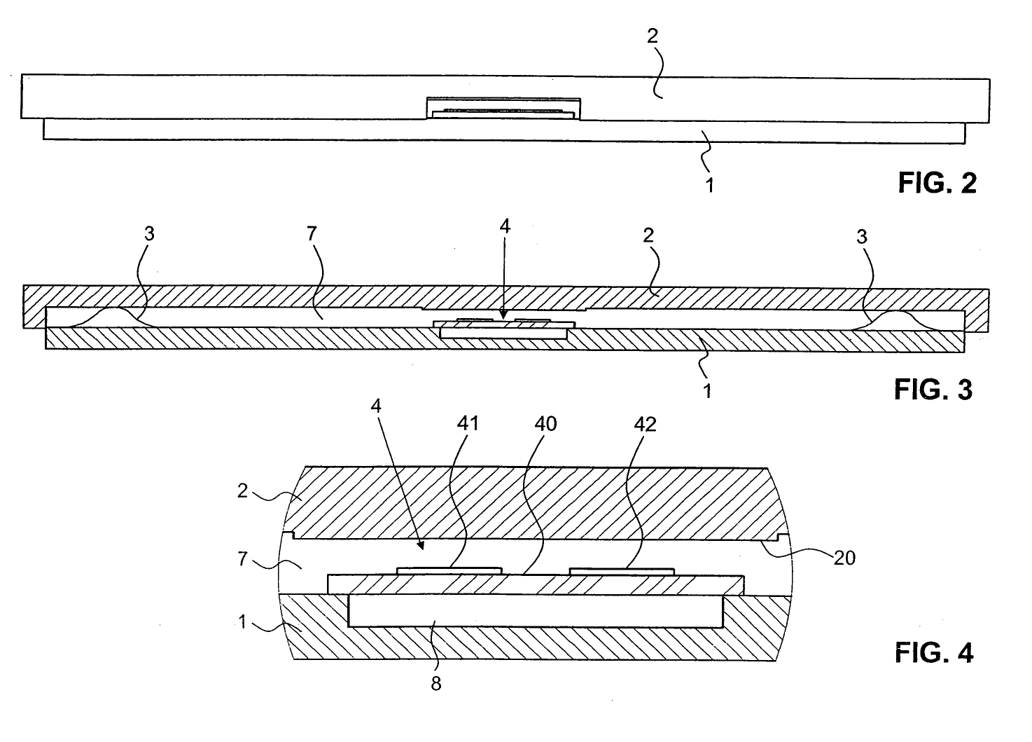

FIGS. 1 to 4 illustrate a first exemplary embodiment of the scales according to the invention. The set of scales has a baseplate 1 and a placement plate 2 which is arranged thereabove. Resilient distance elements 3 are arranged between the two plates 1, 2 such that a hollow space 7 arises between the plates 1, 2. When the placement plate 2 is loaded with an object to be weighed, the distance elements 3 are pressed together and the distance between placement plate 2 and baseplate 1 is reduced.

The two plates 1, 2 are, in this example, of rectangular shape, wherein the placement plate 2 is larger than the baseplate 1. However, they can have any desired shape and shapes which differ from one another. In addition, they can be fabricated from any desired material, wherein the placement plate 2 must be sufficiently stable for carrying an object to be weighed without being deformed. In this example the placement plate 2 and the baseplate 1 are fabricated from metal. However, they can also be made of plastic or glass, for example. The baseplate 1 preferably has a substantially plane-parallel design. The placement plate 2 can be plane-parallel, form a holding bowl or have another shape which is optimized for holding an object to be weighed.

The resilient distance elements 3 can likewise have any desired shape, wherein their elastic restorability defines the maximum loading capacity of the scales. Preferably four distance elements 3 are present and arranged such that they are distributed in the outermost overlap regions of the baseplate 1 and placement plate 2, i.e. in their edge regions. They preferably form the corner points of a common rectangle. It is also possible for three or, depending on the shape of the two plates 1, 2 or the distance elements 3, one or two or more than four distance elements to be present, however.

The distance elements 3 in this example are metal diaphragm springs which are bent from a continuous metal sheet and are provided with concentric regions. Leaf springs, spiral springs or other suitable spring elements having a sufficiently large elastic restoring force can also be used, however.

In the example illustrated here, the distance elements are secured on the baseplate 1 and the placement plate 2 is loosely supported by them. The placement plate 2 can, however, likewise be fixedly connected to the distance elements 3 or the distance elements 3 can be secured on the placement plate 2 and be loosely supported by the baseplate 1.

The set of scales furthermore has a weighing means for determining the weight of the object to be weighed. This weighing means is, according to the invention, at least one inductive proximity sensor. The set of scales therefore has a sensor unit 4 with a printed circuit board 40. Four electric coils 41, 42, 43, 44 are arranged on the printed circuit board 40 and form the four corners of a square. The sensor unit 4 is, in this example, arranged in the central region, specifically in the center of the baseplate 1 or the placement plate 2 in this case. However, it can also be arranged elsewhere. The individual coils 41, 42, 43, 44 can likewise be arranged on various printed circuit boards rather than on one common printed circuit board 40, with the printed circuit boards being arranged such that they are distributed over the baseplate 1 or the placement plate 2. Furthermore, another number of coils may be used, in particular one or three. If there is only one coil, only a weight measurement and not a tilt correction can be carried out, however. Three sensors are required for this.

The coils 41, 42, 43, 44 are preferably of identical design and in this exemplary embodiment they are flat coils formed from conductor tracks, as described in EP 0 913 857. Each coil forms part of a proximity sensor. The counterpart of this is formed by a reference plate 20, which is metallic, ferromagnetic or paramagnetic. It can, as shown in FIG. 4, be a constituent part of the placement plate 2, the corresponding surface of the plate can correspondingly be metalized or coated, or the reference plate can be secured to the placement plate 2. As shown in this example, a common reference plate 20 for all the proximity coils 41, 42, 43, 44 can also be used, or each coil can be assigned its own reference plate.

The printed circuit board 40 is secured on the baseplate 1 above a hollow space 8 thereof, into which hollow space the electronics components (not illustrated here), which are arranged on the printed circuit board 40, can project. The printed circuit board 40 is connected to an electronic evaluation system 5 which has a display unit 50. The electronic evaluation system 5 can also be integrated on the printed circuit board 40 and the display unit 50 can be arranged such that it is directly connected thereto or, as shown here, such that it is spaced apart therefrom. The printed circuit board 40 and display unit 50 are preferably connected by means of electric cables, which in the example shown here extend in a connection passage 6. However, it is also possible to use infrared signal transmission, radio or another wireless signal transmission means.

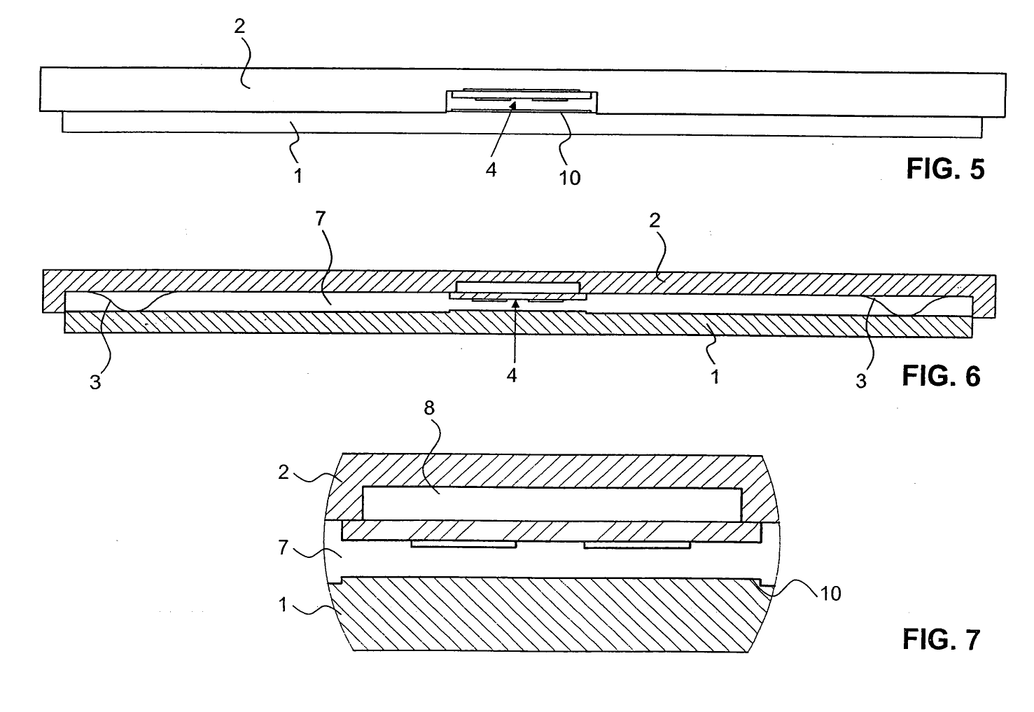

As can be seen in FIGS. 5 to 7, the printed circuit board 40 can also be secured to the placement plate 2 above a hollow space 8 thereof, and the reference plate 10 or plates are arranged in or on the baseplate 1. In this case, the distance elements 3 are preferably likewise secured to the placement plate 2.

Regardless of whether the proximity coils 41, 42, 43, are secured in or on the placement plate 2, or secured in or on the baseplate 1, the operation of the set of scales is the same and corresponds to the measurement principle described in EP 0 913 857: the coils are excited using an alternating current and generate a magnetic field. If the distance between reference plate 10, 20 and coil 41, 42, 43, 44 is changed by placement of an object to be weighted onto the placement plate 2, the non-reactive resistance or the inductance of the coil changes as a function of the change in distance.

The following is one possible measurement principle: the four signals U1, U2, U3, U4 of the four coils 41, 42, 43, 44 are summed in a summing amplifier, and, parallel thereto, a possible inclination of the plate with respect to the perpendicular is calculated in an inclination calculator by forming, for example, the differences between the signal of the fourth coil and the third and, respectively, the first coil and the sum or difference of these two differences being given as the correction value in a correction calculator. In the correction calculator, the sum of the summing amplifier is now corrected using the correction value, and a weight signal is obtained therefrom, which takes into account any possible tilt of the plate. This signal can now be provided with a corresponding calibration value and be displayed in kg or pounds on the display 50 or transmitted to a printer or another electronic unit.

The set of scales can, however, also be used without tilt correction.

The set of scales according to the invention thus has a robust design and provides a great deal of flexibility in the external design of the scales.

### LIST OF REFERENCE NUMERALS

1 baseplate
10 lower reference plate
2 placement plate
20 upper reference plate
3 distance element
4 sensor unit
40 printed circuit board
41 first proximity sensor
42 second proximity sensor
43 third proximity sensor
44 fourth proximity sensor
45 summing amplifier
46 correction calculator
47 inclination calculator
5 electronic evaluation system
50 display window
6 connection passage
7 first hollow space
8 second hollow space

1. A set of scales having a baseplate, and a placement plate, which is arranged at a distance above the baseplate, for the placement of an object to be weighed, having resilient distance elements which are arranged between the baseplate and the placement plate, and having a weighing means for determining the weight of the object, the weighing means being formed by at least one inductive proximity sensor, wherein the at least one proximity sensor, comprises an electric coil and a metallic, ferromagnetic or paramagnetic reference plate, wherein the electric coil is arranged in one of the placement plate and the baseplate, and the reference plate is arranged in the respective other of the placement plate and the baseplate or formed therefrom.

2. The set of scales as claimed in claim 1, wherein the distance elements are arranged such that they are distributed on an edge region of the baseplate and of the placement plate, and in that the at least one proximity sensor is arranged in a central region of the baseplate and of the placement plate.

3. The set of scales as claimed in claim 1, wherein exactly four proximity sensors are present.

4. The set of scales as claimed in claim 3, wherein the four proximity sensors have a common reference plate.

5. The set of scales as claimed in claim 3, wherein the four proximity sensors are arranged in a square.

6. The set of scales as claimed in claim 1, wherein the proximity sensors are connected to a common electronic evaluation system which adds the signals of the four sensors and forms an average value which forms the differences of the signals from at least three sensors and uses them as a correction value in the calculation with the average value.

7. The set of scales as claimed in claim 1, wherein the resilient distance elements are diaphragm springs.

8. The set of scales as claimed in claim 1, wherein exactly four distance elements are present which form corner points of a common rectangle.
